(19) United States
(12) Patent Application Publication
(10) Pub. No.: US 2025/0170587 A1
(43) Pub. Date: May 29, 2025

(54) SYSTEMS AND METHODS FOR OPERATING A CENTRIFUGE SYSTEM

(71) Applicant: National Oilwell Varco, L.P., Houston, TX (US)

(72) Inventors: Floyd Wilder, Magnolia, TX (US); Hector Torres, Conroe, TX (US); Ian Holman, Pearland, TX (US)

(73) Assignee: National Oilwell Varco, L.P., Houston, TX (US)

(21) Appl. No.: 18/833,453

(22) PCT Filed: Jan. 27, 2023
(86) PCT No.: PCT/US2023/011724

§ 371 Date: Jul. 26, 2024

Related U.S. Application Data
(60) Provisional application No. 63/303,830, filed on Jan. 27, 2022.

(51) Int. Cl. B04B 1/20; B04B 13/00; E21B 21/06

(52) U.S. Cl. CPC B04B 1/2016; B04B 2013/006; E21B 21/065

(57) ABSTRACT

A centrifuge system includes an inlet fluid conduit to receive a flow of raw fluid, an outlet fluid conduit to receive a flow of effluent fluid, an effluent sensor to determine a density of the effluent fluid, a centrifuge including an inlet to receive the raw fluid, an effluent outlet to discharge the effluent fluid, and a solids outlet configured to discharge solids separated from the raw fluid by the centrifuge, a feed pump to pump the raw fluid to the inlet of the centrifuge at a selected flowrate, and a controller to automatically adjust at least one of a speed of the feed pump, a rotational speed of a bowl of the centrifuge about a rotational axis, and a rotational speed of a conveyor of the centrifuge about the rotational axis in response to a change in the density of the effluent fluid as determined by the effluent sensor.

### CROSS-REFERENCE TO RELATED APPLICATIONS

This application claims benefit of U.S. provisional patent application Ser. No. 63/303,830 filed Jan. 27, 2022, and entitled “Systems and Methods for Operating a Centrifuge System,” which is hereby incorporated herein by reference in its entirety for all purposes.

### STATEMENT REGARDING FEDERALLY SPONSORED RESEARCH OR DEVELOPMENT

Not applicable.

### BACKGROUND

Centrifuges are used in a variety of applications for separating different materials using centrifugal force. As one example, centrifuges are utilized in drilling systems for forming wellbores that extend into hydrocarbon bearing, subterranean earthen formations. Drilling systems may include a drill bit connected to an end of a drill string that extends into the wellbore from a surface drilling rig or platform. Drilling mud or “mud” may be pumped from a surface pump through the drill string and into the wellbore via one or more ports formed in the drill bit to assist the drill bit in penetrating into the subterranean earthen formation. Centrifuges are utilized in at least some drilling systems for separating undesired solids (e.g., cuttings from the subterranean formation, etc.) from the drilling mud as the drilling mud is recirculated to the drilling rig from the wellbore.

### SUMMARY

An embodiment of a centrifuge system for separating solids from a fluid flow comprises an inlet fluid conduit configured to receive a flow of raw fluid, an outlet fluid conduit configured to receive a flow of effluent fluid, an effluent sensor located along the outlet fluid conduit and configured to determine a density of the effluent fluid received by the outlet fluid conduit, a centrifuge comprising an inlet configured to receive the raw fluid from the inlet fluid conduit, an effluent outlet configured to discharge the effluent fluid received by the outlet fluid conduit, and a solids outlet configured to discharge solids separated from the raw fluid by the centrifuge, a bowl rotatable about a rotational axis of the centrifuge, and a conveyor located within the bowl and configured to rotate about the rotational axis, and wherein the conveyor is configured to separate solids present in the raw fluid received by the inlet to thereby produce the effluent fluid discharged at the effluent outlet, a feed pump in fluid communication with both the inlet fluid conduit and the inlet of the centrifuge, wherein the feed pump is configured to pump the raw fluid to the inlet of the centrifuge at a selected flowrate, and a controller connected to the effluent sensor and the centrifuge, wherein the controller is configured to automatically adjust at least one of a speed of the feed pump, a rotational speed of the bowl of the centrifuge about the rotational axis, and a rotational speed of the conveyor of the centrifuge about the rotational axis in response to a change in the density of the effluent fluid as determined by the effluent sensor. In some embodiments, the centrifuge system comprises a bowl drive connected to the bowl of the centrifuge and the controller and configured to control the rotational speed of the bowl, a conveyor drive connected to the conveyor of the centrifuge and the controller and configured to control the rotational speed of the conveyor, and a pump drive connected to the feed pump and the controller and configured to control the speed of the feed pump. In some embodiments, each of the bowl drive, the conveyor drive, and the pump drive comprises a variable frequency drive (VFD). In certain embodiments, the controller comprises a memory device in which a preset rotational speed of the bowl, a preset rotational speed of the conveyor, and a preset initial speed of the feed pump are stored. In certain embodiments, the controller is configured to automatically increase at least one of the speed of the feed pump from the preset initial speed of the feed pump by a predetermined feed pump speed increment, the rotational speed of the bowl from the preset rotational speed of the bowl by a predetermined bowl rotational speed increment, and the rotational speed of the conveyor from the preset rotational speed of the conveyor by a predetermined conveyor rotational speed increment. In some embodiments, the controller is configured to automatically decrease a speed of the feed pump in response to the controller determining that an alarm torque limit of the centrifuge has been met. In some embodiments, the alarm torque limit comprises at least one of a bowl alarm torque limit associated with the bowl of the centrifuge, a conveyor alarm torque limit associated with the conveyor of the centrifuge, and a feed pump alarm torque limit associated with the feed pump. In some embodiments, the controller is configured to automatically shut down operation of the centrifuge in response to the controller determining that an alarm torque limit of the centrifuge has been exceeded.

An embodiment of a method of operating a centrifuge system for separating solids from a fluid flow comprising (a) pumping a flow of a raw fluid by a feed pump to an inlet of a centrifuge of the centrifuge system, (b) operating the centrifuge to separate solids present in the raw fluid received by the inlet to thereby produce an effluent fluid from the raw fluid, (c) discharging a flow of the effluent fluid from an effluent outlet of the centrifuge, (d) discharging a flow of solids separated from the raw fluid from a solids outlet of the centrifuge, (e) determining a density of the flow of the effluent fluid discharged from the centrifuge by an effluent sensor, and (f) automatically adjusting by a controller of the centrifuge system at least one operational parameter of the centrifuge system in response to a change in the density of the effluent fluid as determined by the effluent sensor. In some embodiments, the method comprises (g) operating a component of the centrifuge system associated with the at least one operational parameter at a preset initial value stored in a memory device of the controller, and (h) automatically adjusting by the controller at least one operational parameter from the preset initial value by a predetermined increment. In some embodiments, (g) comprises at least one of operating the feed pump at a preset initial pump speed, operating a bowl of the centrifuge at a preset initial bowl speed, and a conveyor of the centrifuge at a preset initial conveyor speed. In some embodiments, (h) comprises automatically increasing by the controller at least one of a speed of the feed pump from the initial pump speed by a predetermined pump speed increment, a speed of the bowl of the centrifuge from the initial bowl speed by a predetermined bowl speed increment, and a speed of the conveyor of the centrifuge from the initial conveyor speed by a predetermined conveyor speed increment. In certain embodiments, the method comprises (g) automatically decreasing by the controller a speed of the feed pump in response to the controller determining that an alarm torque limit of the centrifuge has been met. In certain embodiments, the alarm torque limit comprises at least one of a bowl alarm torque limit associated with the bowl of the centrifuge, and a conveyor alarm torque limit associated with the conveyor of the centrifuge, and a feed pump alarm torque limit associated with the feed pump. In some embodiments, the method comprises (g) automatically shutting down by the controller operation of the centrifuge in response to the controller determining that an alarm torque limit of the centrifuge has been exceeded.

An embodiment of a method of operating a centrifuge system for separating solids from a fluid flow comprises (a) pumping a flow of a raw fluid by a feed pump to an inlet of a centrifuge of the centrifuge system, (b) rotating both a bowl and a conveyor of the centrifuge about a rotational axis of the centrifuge system to separate solids present in the raw fluid received by the inlet to thereby produce an effluent fluid, (c) discharging a flow of the effluent fluid from an effluent outlet of the centrifuge, (d) discharging a flow of solids separated from the raw fluid from a solids outlet of the centrifuge, (e) determining a density of the flow of the effluent fluid discharged from the centrifuge by an effluent sensor, and (f) automatically adjusting by a controller of the centrifuge system at least one of a speed of the feed pump, a rotational speed of the bowl of the centrifuge about the rotational axis, and a rotational speed of the conveyor of the centrifuge about the rotational axis in response to a change in the density of the effluent fluid as determined by the effluent sensor. In some embodiments, the method comprises (g) automatically operating by the controller at least one of the feed pump at a preset initial pump speed stored in a memory device of the controller, the bowl of the centrifuge at a preset initial bowl speed stored in a memory device of the controller, and the centrifuge at a preset initial centrifuge speed stored in a memory device of the controller, wherein (f) comprises automatically increasing at least one of the speed of the feed pump from the initial pump speed, the rotational speed of the bowl of the centrifuge from the initial bowl speed, and the rotational speed of the conveyor of the centrifuge from the initial conveyor speed in response to a change in the density of the effluent fluid as determined by the effluent sensor. In certain embodiments, the method comprises (g) automatically decreasing by the controller the speed of the feed pump in response to the controller determining that an alarm torque limit of the centrifuge has been met. In certain embodiments, the alarm torque limit comprises at least one of a bowl alarm torque limit associated with the bowl of the centrifuge, and a conveyor alarm torque limit associated with the conveyor of the centrifuge, and a feed pump alarm torque limit associated with the feed pump. In some embodiments, the method comprises (g) automatically shutting down by the controller operation of the centrifuge in response to the controller determining that an alarm torque limit of the centrifuge has been exceeded.

### BRIEF DESCRIPTION OF THE DRAWINGS

For a detailed description of exemplary embodiments of the disclosure, reference will now be made to the accompanying drawings in which:

FIG. 1 is a perspective view of an embodiment of an embodiment of a drilling system;

FIG. 2 is a schematic view of an embodiment of a centrifuge system of the drilling system of FIG. 1;

FIG. 3 is a side cross-sectional view of an embodiment of a centrifuge of the centrifuge system of FIG. 2; and

FIGS. 4-6 are a flowchart of an embodiment of a method for operating the centrifuge system of FIG. 2.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to “up,” “upper,” “upwardly,” “down,” “lower,” “downwardly” and the like in the description and the claims is made for purposes of clarity.

As described above, centrifuges are used in a variety of applications for separating different materials using centrifugal force, including in drilling systems for removing undesired solids from drilling mud which has been recirculated from a wellbore to the surface. For example, a drilling system may include a centrifuge system including a centrifuge having an inlet for receiving “raw” or unprocessed drilling mud recirculated from the wellbore, and a discharge from which an effluent or processed drilling mud is discharged and from which at least some of the solids of the raw drilling mud have been removed. The raw drilling mud bay be pumped to the inlet of the centrifuge by a feed pump of the centrifuge system.

In some applications, it may be desired to maximize a “cut” or reduction in density between the raw drilling mud and the effluent drilling mud. The maximization in cut between the raw and effluent drilling muds is typically accomplished in a trial-and-error approach in which different operational parameters of the centrifuge system are adjusted manually (e.g., through one or more drives or controllers of the centrifuge system) by an operator of the centrifuge system until a desired cut is produced by the centrifuge system. However, this may be a time consuming and cumbersome process in which the operator of the centrifuge system may be required to perform lab testing of the effluent drilling mud to determine the impact on any changes to the operational parameters of the centrifuge system.

Accordingly, embodiments of systems and methods for operating a centrifuge system are described herein in which one or more operational parameters of the centrifuge system are adjusted automatically by a controller of the centrifuge system to quickly and automatically maximize the cut or reduction in density between the raw drilling mud and the effluent drilling mud, both minimizing the time required for maximizing the cut and eliminating the need for an operator of the centrifuge system to manually adjust the operational parameters of the centrifuge system and/or to perform laboratory testing of the effluent drilling mud.

In some embodiments, the controller of the centrifuge system may automatically adjust at least one operational parameter of the centrifuge system in response to a change in the density of the effluent drilling mud as determined by an effluent sensor of the centrifuge system in signal communication with the controller. In some embodiments, the one or more operational parameters of the centrifuge system may comprise at least one of a speed of a feed pump of the centrifuge system, a rotational speed of a bowl of a centrifuge of the centrifuge system, and a rotational speed of a conveyor of the centrifuge. The adjusting may be an increase of the operational parameter in response to a reduction in the density of the effluent drilling mud, and/or a decrease of the operational parameter in response to an increase in the density of the effluent drilling mud.

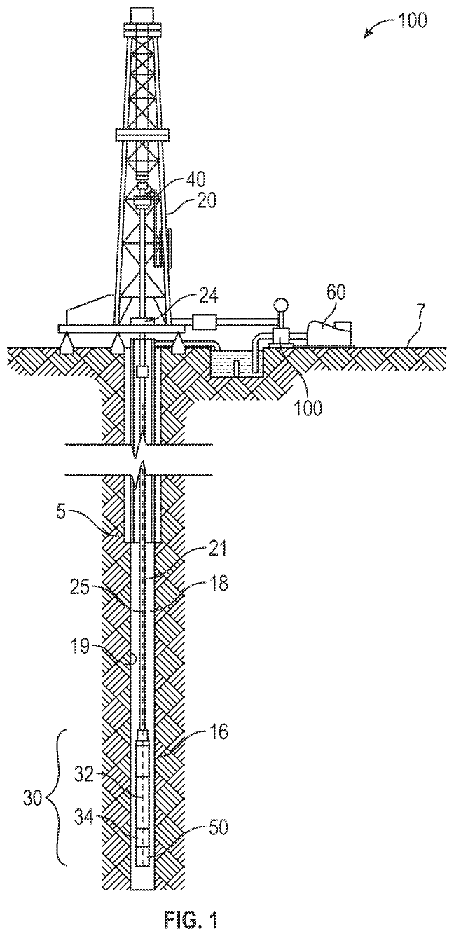

Referring to FIG. 1, an embodiment of a well or drilling system 10 including a centrifuge system 100 is shown. Centrifuge system 100 may also be referred to herein as a solids control system 100. Additionally, it may be understood that the description of centrifuge system 100 as comprising a component of drilling system 10 only serves as an example, and centrifuge systems similar in configuration with the centrifuge system 100 described below may be utilized in a variety of different applications including, for example mining slurry separation applications, water treatment applications, industrial product separation applications, etc.

Drilling system 10 is generally configured for drilling a borehole 16 extending through an earthen formation 5 from a surface 7. In this exemplary embodiment, drilling system 10 includes a drilling rig 20 disposed at the surface 7, a drillstring 21 extending downhole from rig 20 along a central or longitudinal axis 25, a bottomhole assembly (BHA) 30 coupled to the lower end of drillstring 21, and a drill bit 50 attached to the lower end of BHA 30. Drilling system 10 additionally includes the centrifuge system 100 located at the surface 7 as well as a surface or mud pump system 60 for pumping drilling fluid or mud through drillstring 21 via a kelly 40 coupled to an upper end of drillstring 21. Additionally, rig 20 includes a rotary system 24 for imparting torque to an upper end of drillstring 21 to thereby rotate drillstring 21 in borehole 16. In this exemplary embodiment, rotary system 24 comprises a rotary table located at a rig floor of rig 20; however, in other embodiments, rotary system 24 may comprise other systems for imparting rotary motion to drillstring 21, such as a top drive which may also be used to provide pressurized drilling mud to drillstring 21 in lieu of the kelly 40.

In some embodiments, BHA 30 may include a downhole mud motor 32 for converting the fluid pressure of the drilling mud pumped downward through drillstring 21 by mud pump system 60 into rotational torque for driving the rotation of drill bit 50. The drill bit 50 may be connected to the downhole mud motor 32 via a bearing mandrel 34 positioned between the downhole mud motor 32 and drill bit 50. With force or weight applied to the drill bit 50, also referred to as weight-on-bit (“WOB”), the rotating drill bit 50 engages the earthen formation and proceeds to form borehole 16 along a predetermined path toward a target zone. The drilling mud pumped down the drillstring 21 and through BHA 30 passes out of the face of drill bit 50 and back up an annulus 18 formed between drillstring 21 and the sidewall 19 of borehole 16. The drilling mud cools the bit 50, and flushes the cuttings away from the face of bit 50 and carries the cuttings to the surface 7 where the recirculated drilling mud is received by the centrifuge system 100.

As will be described further below, centrifuge system 100 separates out or remove at least some materials from the recirculated drilling mud before the drilling mud is received by the mud pump system 60. For example, centrifuge system 100 may remove at least some of the drill cuttings and/or other solids from the drilling mud before the drilling mud is received by the mud pump system 60. The types of materials removed from the drilling mud by centrifuge system 100 may correspond to one or more different modes of operation of centrifuge system 100 which may be implemented by drilling system 10 as the operation of drilling system 10 changes over time. For example, at some times during the operation of drilling system 10, centrifuge system 100 may be configured to execute a barite recovery mode of operation in which barite solids having a relatively high specific gravity are targeted for removal from the drilling mud by centrifuge system 100. As another example, at some times during the operation of drilling system 10, centrifuge system 100 may be configured to execute a low gravity solids removal mode of operation in which low gravity solids (LGS) having a low specific gravity are targeted for removal from the drilling mud by centrifuge system 100. In yet another example, at some times during the operation of drilling system 10, centrifuge system 100 may execute a dewatering mode of operation in which all remaining solids in the drilling mud are targeted for removal by centrifuge system 100. It may be understood that in some embodiments centrifuge system 100 may execute multiple modes of operation concurrently via separate centrifuge subsystems.

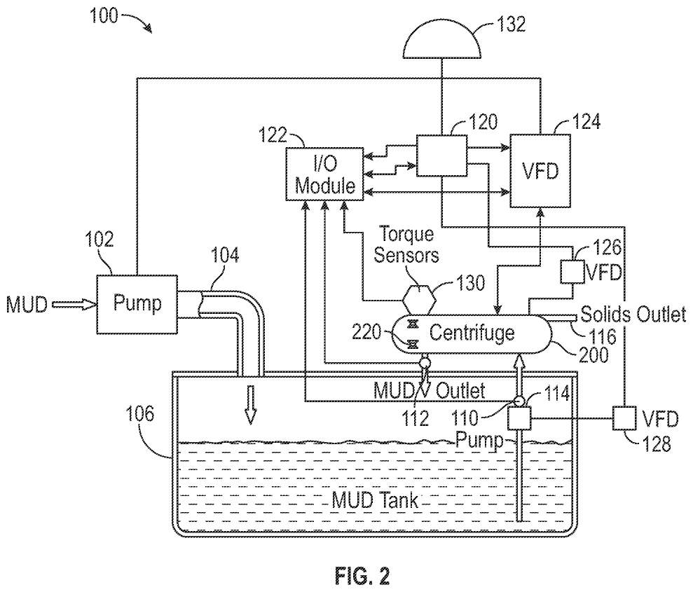

Referring now to FIG. 2, an embodiment of the centrifuge system 100 is shown in greater detail. In this exemplary embodiment, centrifuge system 100 generally includes an inlet pump 102, a mud tank 106, a control system or controller 120, an input/output (I/O) module 122, a plurality of variable frequency drives (VFDs) 124, 126, and 128, and a centrifuge 200.

The inlet pump 102 of centrifuge system 100 that receives “raw” drilling mud recirculated from the wellbore (upstream from mud pump system 60) and pumps the raw drilling mud through an inlet fluid conduit or pipe 104 of centrifuge system 100 into mud tank 106. In this exemplary embodiment, centrifuge system 100 includes a raw density sensor 110, and an effluent density sensor 112; however, it may be understood that in other embodiments, centrifuge system 100 may not include one or more of sensors 110, 112.

The centrifuge 200 of centrifuge system 100 receives raw drilling mud from mud tank 106 via the feed pump 114 which pumps drilling mud from mud tank 106 into centrifuge 200. The raw density sensor 110 is positioned at a discharge of the feed pump 114 and measures or determines the density of the raw drilling mud being discharged from the feed pump 114 as it flows towards and into the centrifuge 200. Additionally, the effluent density sensor 112 is positioned at a discharge or outlet of the centrifuge 200 and measures or determines the density of a “processed” or “effluent” drilling mud discharged from centrifuge 200. It may be understood that sensors 110 and 112 may be positioned internal or external the mud tank 106.

While an embodiment of centrifuge 200 is described in greater detail below, it may be understood that the configuration of centrifuge 200 may vary. Centrifuge 200 processes the raw drilling mud received from mud tank 106 to remove selected solids therefrom whereby a density of the drilling mud is altered such that the density of the effluent drilling mud discharged from centrifuge 200 is different from the density of the raw drilling mud received by centrifuge 200. The selected solids removed from the drilling mud by centrifuge 200 are discharged via a solids outlet 116 of centrifuge 200. Additionally, in this exemplary embodiment, the raw drilling mud processed by centrifuge 200 (which may include desired solids not removed by centrifuge 200) is recirculated to the mud tank 106 as an effluent drilling mud discharged from a mud or effluent outlet 118 of centrifuge 200. It may be understood that the inlet pump 102 and centrifuge 200 may operate continuously for extended periods of time. It may be understood that in other embodiments the centrifuge 200 may not recirculate the effluent drilling mud to the mud tank 106.

The controller 120 of centrifuge system 100 controls the operation of I/O module 122 and VFDs 124, 126, and 128. It may be understood that controller 120 may comprise a computer system including a processor and a memory device which may store instructions in the form of software which may be executed by the processor of controller 120. VFDs 124, 126, and 128 control various parameters of the centrifuge 200. In this exemplary embodiment, and as will be discussed further herein, VFD 124 comprises a bowl VFD 124 which controls a bowl speed of centrifuge 200; VFD 126 comprises a conveyor VFD 126 which controls the operation of a screw conveyor of centrifuge 200, and VFD 128 comprises a feed or inlet VFD 128 which controls a flowrate of raw drilling mud entering the centrifuge 200 by controlling the operation of feed pump 114.

In this exemplary embodiment, centrifuge system 100 includes one or more torque sensors 130 which measure or determine torque applied to different components of centrifuge 200 during operation and send signals indicative of measured torque to the I/O module 122. The I/O module 122 of centrifuge system 100 may send data from the sensors of centrifuge system 100 (e.g., density sensors 110, 112, torque sensors 130, etc.) to the controller 120, and send command signals generated by the controller 120 to the bowl VFD 124. I/O module 122 additionally provides density measurements (generated from data provided by sensors 112, 112) and torque measurements (generated by sensors 130) to the controller 120.

Controller 120 may send directly command signals to the conveyor VFD 126 and feed VFD 128; however, it may be understood that the routing of command signals generated by controller 120 to the VFDs 124, 126, and 128 may vary. Additionally, controller 120 may determine a “cut” or difference in density between the raw drilling mud (measured by raw density sensor 110) and the effluent drilling mud (measured by sensor effluent density sensor 112). In this exemplary embodiment, the measurements provided by sensors 110, 112, and 130, as well as other data may be displayed to an operator of centrifuge system 100 via a display device 132 (e.g. a monitor, screen, panel, laptop, handheld or desktop computer, etc., remote and/or on site) that is connected to controller 120.

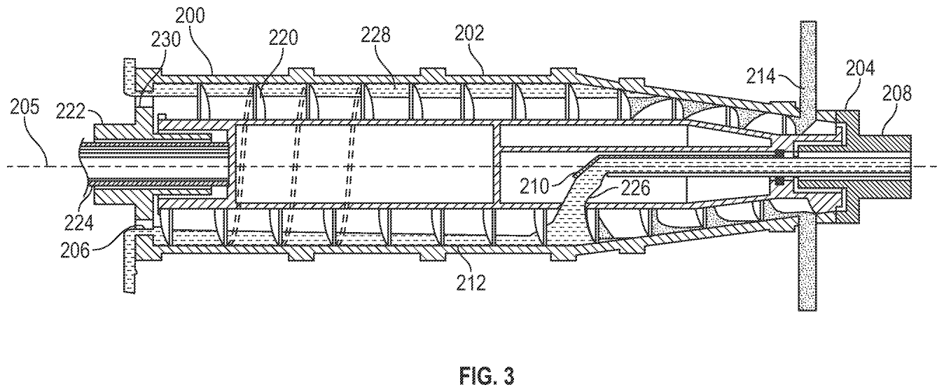

Referring now to FIG. 3, an embodiment of the centrifuge 200 of centrifuge system 100 is shown in greater detail. Centrifuge 200 generally includes a bowl 202 and a screw conveyor 220 housed within the bowl 202. Bowl 202 is configured to rotate about a longitudinal axis 205 of the bowl 202 and includes a longitudinal first open end 204 and a longitudinal second open end 206 opposite the first open end 204. Longitudinal axis 205 may also be referred to herein as rotational axis 205. The first open end 204 of bowl 202 receives a drive flange 208 connected to a driveshaft (not shown in FIG. 3) for rotating the bowl 202 about the rotational axis 205. The rotational speed of bowl 202 and the driveshaft connected thereto may be controlled by the bowl VFD 124 described above. Additionally, drive flange 208 receives a feed tube or line 210 for introducing the drilling mud from mud tank 106 into bowl 202. The flowrate of drilling mud through feed tube 210 and into bowl 202 may be controlled by the feed VFD 128 described above.

The screw conveyor 220 of centrifuge 200 extends coaxially within bowl 202 and is supported within bowl 202 by a hollow flanged shaft 222 received within the second open end 206 of bowl 202. In this configuration, screw conveyor 220 is permitted to rotate about rotational axis 205 in the same rotational direction as bowl 202 but at a rotational speed that may vary from the rotational speed of bowl 202 about rotational axis 205. Hollow flanged shaft 222 receives a dive shaft of an external transmission 224 of conveyor 220. In this exemplary embodiment, transmission 224 of conveyor 220 comprises a planetary transmission or gearbox; however, it may be understood that the configuration of transmission 224 may vary. The rotational speed of transmission 224 and bowl 202 may be matched about the rotational axis 205, where the transmission 224 and VFD 126 together control the differential rotational speed between the bowl 202 and screw conveyor 220.

Screw conveyor 220 includes one or more ports or openings 226 located near an outlet of feed tube 210 such that centrifugal forces generated by the rotation of bowl 202 displace the drilling mud radially outwards away from rotational axis 205 and into an annulus 228 formed between the bowl 202 and screw conveyor 220. A liquid portion of the raw drilling mud received by centrifuge 200 travels towards the second open end 206 of bowl 202 while at least some of the solids entrained in the drilling mud settle against an inner surface 212 of the bowl 202 due to the G forces generated by the rotation of bowl 202. The solids located on the inner surface 212 of bowl 202 are scraped by the screw conveyor 220 and conveyed by the conveyor 220 back towards the first open end 204 of bowl 202. The scraped solids conveyed by the screw conveyor 220 are discharged through one or more solids discharge ports or openings 214 formed in the bowl 202 and located proximal first open end 204. Additionally, weirs 230 are provided through the hollow flanged shaft 222 for discharging a processed or effluent drilling mud from which the solids discharged through solids discharge ports 214 have been separated. As described above, the effluent drilling mud is recirculated to the mud tank 106 via the effluent outlet 118 of centrifuge 200.

Components of centrifuge 200 including, for example, bowl 202 and screw conveyor 220 are subject to reactive torque during the operation of centrifuge 200. The reactive torques applied to the components of centrifuge may vary in response to changes in certain operational parameters of centrifuge 200 including, for example, a bowl speed of bowl 202 and a conveyor speed of conveyor 220. Additionally, components of centrifuge 200 may have a maximum torque to which may be applied to the given component which may not be exceeded without risking destroying or otherwise damaging the component. For example, bowl 202 may have a bowl maximum torque limit which may not be exceeded and screw conveyor 220 may have a conveyor maximum torque limit which may not be exceeded and which may vary from the bowl maximum torque limit.

The reactive torque applied to components of centrifuge 200 may be monitored by controller 120 via data provided by torque sensors 130. The memory device of controller 120 may store one or more predetermined alarm torques corresponding to one or more components of centrifuge 200 (e.g., a bowl torque alarm, a conveyor torque alarm, a feed pump alarm torque, etc.). A torque alarm of a given component may be a predetermined percentage of the maximum torque limit of the component (e.g., 90% of the maximum torque limit, etc.). In some embodiments, controller 120 may automatically modify or even shutdown operation of centrifuge 200 should one of the torques monitored by torque sensors 130 reach or exceed the alarm torque limit for the given component.

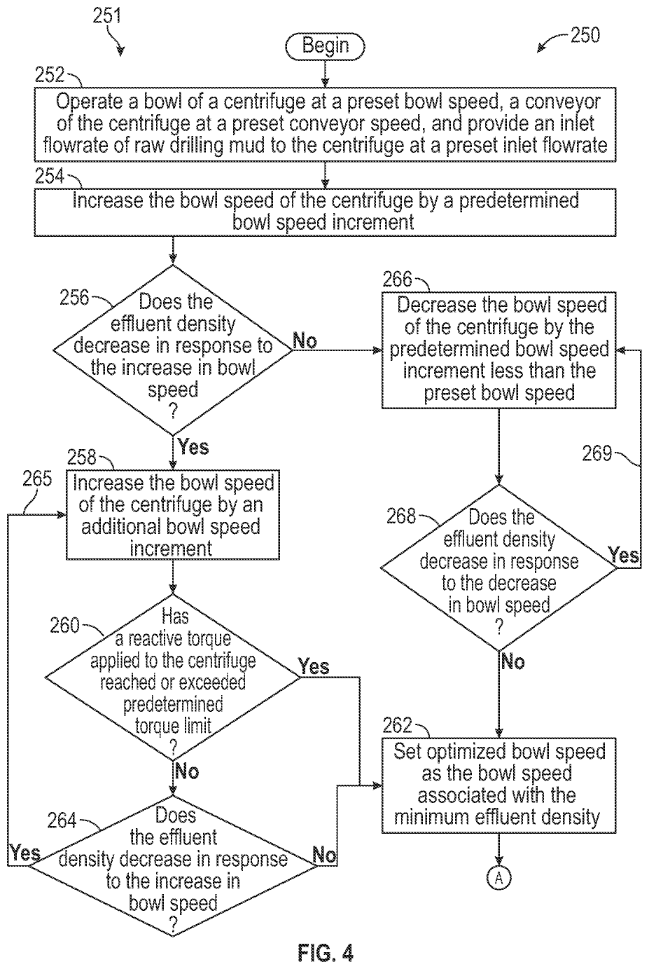

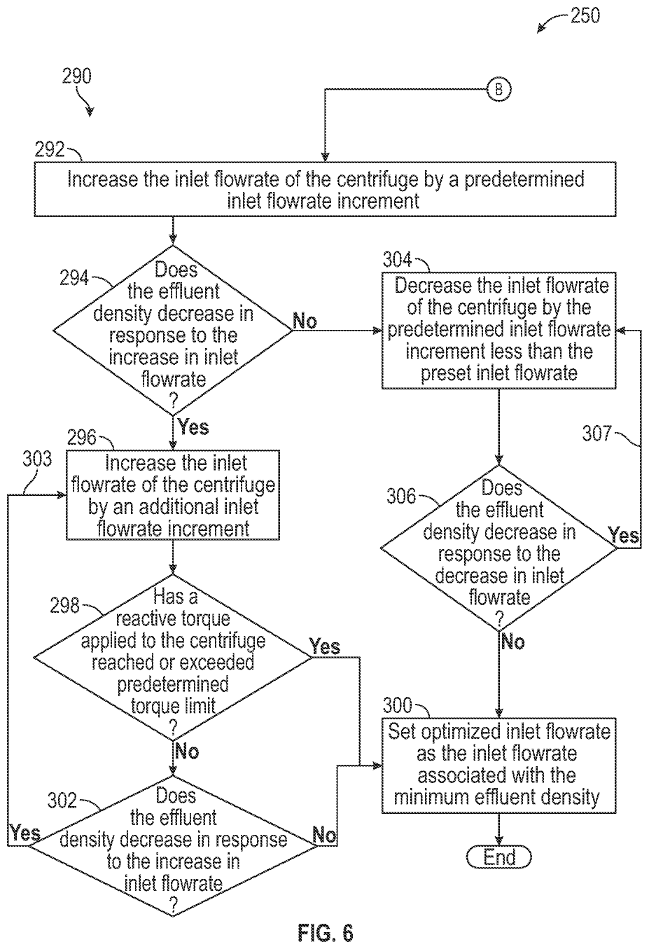

Referring now to FIGS. 2-6, an embodiment of a method 250 for operating the centrifuge system 100 of FIG. 2 is shown in FIGS. 4-6. Particularly, method 250 optimizes several operational parameters of centrifuge system 100 to thereby minimize the density of the effluent drilling mud processed by centrifuge 200 and maximize the reduction in density between the effluent drilling mud and the raw drilling mud received by centrifuge 200. As described below, the operational parameters include a flowrate or speed of the feed pump 114, a speed of the bowl 202 of centrifuge 200, and a speed of the conveyor 220 of centrifuge; however, it may be understood that the operational parameters optimized by method 250 may vary from these three operational parameters discussed further below.

It may also be understood that method 250 automates the optimization of the parameters of centrifuge system 100 to automatically minimize the density of the effluent drilling mud without requiring the manual intervention by an operator of the centrifuge system 100. Particularly, the steps of method 250 which are described further herein may be embodied in instructions which are stored in the memory device of the controller 120 of centrifuge system 100. Thus, in at least some embodiments, controller 120 may be configured to perform method 250 automatically without manual intervention by an operator of centrifuge system 100. Controller 120 may execute method 250 using data provided by sensors 110, 112, and/or 130, and using VFDs 124, 126, and 128 to control the various parameters of centrifuge system 100 automatically optimized by method 250.

For the sake of convenience, method 250 is described herein with respect to optimizing the centrifuge system 100 shown in FIG. 2; however, it may be understood that method 250 may be applied to other centrifuge systems which differ in configuration from centrifuge system 100. In this exemplary embodiment, method 250 includes three separate stages: a first stage 251 in which a rotational speed of the bowl 202 about rotational axis 205 of centrifuge 200 is optimized, a second stage 270 in which a rotational speed of the screw conveyor 220 about rotational axis 205 is optimized, and a third and final stage 290 in which an inlet flowrate of raw drilling mud entering centrifuge 200 from feed pump 114 is optimized. While in this exemplary embodiment the speed of bowl 202 is optimized first, the speed of screw conveyor 220 is optimized second, and the inlet flowrate of raw drilling mud is optimized third, it may be understood that in other embodiments the ordering of stages 251, 270, and 290 of method 250 may vary.

Beginning with first stage 251, in this exemplary embodiment, method 250 begins at method step 252 where the bowl 202 of centrifuge 200 is operated at a initial bowl speed, the conveyor 220 is operated at a initial conveyor speed, and an inlet flowrate of raw drilling mud is provided to the centrifuge 200 at a preset inlet flowrate. The initial bowl speed, conveyor speed, and inlet flowrate may each be saved in the memory device of controller 120. Additionally, the controller 120 may execute method step 252 using the VFDs 124, 126, and 128 to control the bowl speed, conveyor speed, and inlet flowrate, respectively.

In some embodiments, there may be multiple initial bowl speeds, conveyor speeds, and inlet flowrates depending upon the current mode of operation of centrifuge system 100. For example, there may be a first initial bowl speed, conveyor speed, and inlet flowrate associated with a barite recovery mode of operation of centrifuge system 100, a second initial bowl speed, conveyor speed, and inlet flowrate associated with a LGS removal mode of operation, and a third initial bowl speed, conveyor speed, and inlet flowrate associated with a dewatering removal mode of operation where the first, second, and third initial bowl speeds may vary from one another, the first, second, and third initial conveyor speeds may vary from one another, and/or the first, second, and third preset inlet flowrates may vary from one another. In some embodiments, an operator of centrifuge system 100 may input into controller 120 (e.g., via an IO device) the current mode of operation to ensure the correct initial bowl speed, conveyor speed, and inlet flowrate are selected. In other embodiments, controller 120 may automatically determine the current mode of operation of conveyor system 100. The initial bowl speed, conveyor speed, and inlet flowrate may correspond to an initial estimate or best guess for the bowl speed, conveyor speed, and inlet flowrate that will provide a minimum density of the effluent drilling mud, which is dependent on the current mode of operation of centrifuge system 100.

With the bowl speed, conveyor speed, and inlet flowrate presets implemented, method 250 proceeds at method step 254 where the bowl speed of bowl 202 is increased from the initial bowl speed by a predetermined bowl speed increment. The bowl speed increment may be predefined change in revolutions per minute (RPM) of the bowl 202 about rotational axis 205. For example, the bowl speed increment may be approximately between 10 RPM and 50 RPM; however, it may be understood that the bowl speed increment may vary in different embodiments, and may also vary depending on the current mode of operation of centrifuge system 100.

At method step 256 of method 250, it is determined whether the density of the effluent drilling mud discharged by the centrifuge 200 has decreased in response to the increase in bowl speed of the bowl 202 executed at method step 254. Method step 256 may be executed by controller 120 based on measurements provided by effluent density sensor 112. In other embodiments, method step 256 may comprise determining whether the difference in density between the raw drilling mud (determined from measurements provided by raw density sensor 110) and the effluent drilling mud has increased in response to the increase in bowl speed of the bowl 202 of centrifuge 200.

In this exemplary embodiment, if the determination at method step 256 is “YES,” then the method 250 proceeds to method step 258 where the RPM of bowl 202 of centrifuge 200 is increased by an additional bowl speed increment. Following the increase in bowl speed at method step 258, method 250 proceeds to method step 260 where it is determined whether a reactive torque applied to the centrifuge 200 has reached or exceeded a predetermined limit. For example, as described above, changes in the bowl speed of bowl 202, the conveyor speed of screw conveyor 220, and/or the inlet flowrate of raw drilling mud may result in changes to the reactive torque applied to the bowl 202, screw conveyor 220, and/or other components of centrifuge 200 as well as feed pump 114.

Method step 260 ensures the increase in bowl speed at method step 260 does not reach or exceed a predetermined torque limit with respect to one of the components of centrifuge system 100 including, for example, bowl 202 and screw conveyor 220 of centrifuge 200, and feed pump 114. The controller 120 may execute method step 260 using measurements provided by torque sensors 130 of centrifuge system 100. In some embodiments, the torque limit may comprise several different torque limits corresponding to different components of centrifuge 200. For example, in some embodiments, the torque limit may comprise the alarm torque limits for at least some of the components of centrifuge system 100, including bowl 202 of centrifuge 200, screw conveyor 220 of centrifuge 200, and feed pump 114.

Should a “YES” determination be made at method step 260, then method 250 proceeds to method step 262 where an optimized bowl speed of the bowl 202 of centrifuge 200 is set which provides the minimum density in the effluent drilling mud which does not exceed the torque limit. Particularly, the optimized bowl speed comprises the bowl speed an increment less than the bowl speed which triggered the “YES” determination at method step 260. As an example, should a bowl speed of bowl 202 be increased from 2,000 RPM (which did not trigger a “YES” determination at method step 258) to 2,050 RPM, and the bowl speed of 2,050 RPM triggers a “YES” determination at method step 260, then at method step 262 the optimized bowl speed would be set at 2,000 RPM. In some embodiments, method 250 may not include method step 260. In other embodiments, method 250 may include an additional method step between method steps 254 and 256 which is similar to method step 260 described above.

Actions may be performed (e.g., by controller 120) in addition to setting the optimized bowl speed in response to a “YES” determination at method step 260. For example, should one of the torque limits have been met, then a speed of the feed pump may be reduced in an attempt to reduce the reactive torque which has met the torque limit. Additionally, should one of the torque limits have been exceeded, then operation of the centrifuge may be shutdown. For example, operation of the feed pump and components of the centrifuge such as bowl and screw conveyor thereof may be shutdown.

Should a “NO” determination be made at method step 260, then method 250 proceeds to method step 264 where it is determined whether the density of the effluent drilling mud discharged by the centrifuge 200 has decreased in response to the additional increase in bowl speed of the bowl 202 executed at method step 258.

If the determination at method step 264 is “YES,” then the method 250 returns to method step 258 as indicated by arrow 265 where the RPM of bowl 202 of centrifuge 200 is increased by an additional bowl speed increment. In some embodiments, the bowl speed of bowl 202 is increased iteratively until a “NO” determination is made at either method step 260 or method step 264. Following the “NO” determination at method step 264, method 250 proceeds to method step 262 where an optimized bowl speed of the bowl 202 of centrifuge 200 is set which provides the minimum density in the effluent drilling mud and which does not exceed the torque limit. This optimized bowl speed comprises the bowl speed following the final incremental increase in bowl speed at method step 258 before the “NO” determination is made at method step 264. To state in other words, the optimized bowl speed comprises the maximum bowl speed obtained before the “NO” determination is made at method step 264.

Returning to method step 256, should a “NO” determination be made at step 256, method 250 proceeds from method step 256 to method step 266 where the bowl speed of bowl 202 is decreased from the initial bowl speed by the predetermined bowl speed increment. To state in other words, method step 266 includes decreasing the bowl speed by two bowl speed increments—by a first bowl speed increment to return the bowl speed to the initial bowl speed, and by a second increment to reduce the bowl speed to a bowl speed that is one bowl speed increment less than the initial bowl speed.

In this exemplary embodiment, method 250 proceeds to method step 268 where it is determined whether the density of the effluent drilling mud discharged by the centrifuge 200 has decreased in response to the decrease in the bowl speed of the bowl 202 executed at method step 266. If the determination at method step 268 is “YES,” then the method 250 returns to method step 266 as indicated by arrow 269 where the RPM of bowl 202 of centrifuge 200 is decreased by an additional bowl speed increment. In some embodiments, the bowl speed of bowl 202 is decreased iteratively until a “NO” determination is made at method step 268.

Following the “NO” determination at method step 268, method 250 proceeds to method step 262 where an optimized bowl speed of the bowl 202 of centrifuge 200 is set which provides the minimum density in the effluent drilling mud and which does not exceed the torque limit. This optimized bowl speed comprises the bowl speed following the final incremental decrease in bowl speed at method step 266 before the “NO” determination is made at method step 268. To state in other words, the optimized bowl speed comprises a minimum bowl speed obtained before the “NO” determination is made at method step 268. This optimized bowl speed may either be the initial bowl speed (should the “NO” determination be made at method step 268 following the first iteration of method step 266) or a bowl speed that is less than the initial bowl speed (should the “NO” determination be made on the second or later iteration of method step 266).

Additionally, in some embodiments, method 250 may include an additional method step between method steps 266 and 268 similar to method step 260 in which it is determined whether a reactive torque applied to the centrifuge (including the feed pump) has reached or exceeded the torque limit in response to the decrease in bowl speed of the bowl 202. As with method step 260, this additional method step would result in a return to the bowl speed preceding the most recent decrease in bowl speed (i.e., a bowl speed one bowl speed increment greater than the current bowl speed) at method 266 should a “YES” determination be made at this additional method step.

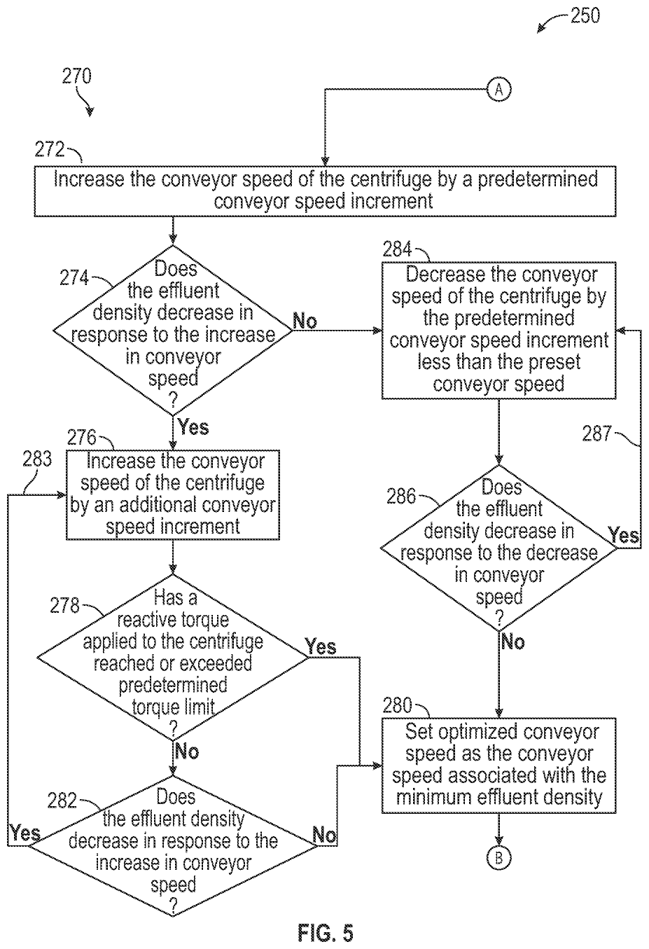

As described above, in this exemplary embodiment, first stage 251 sets an optimized bowl speed of the bowl 202 of centrifuge 200. The method steps described above of first stage 251 may be executed automatically without manual intervention by the controller 120 of centrifuge system 100. Following the setting of the optimized bowl speed at method step 262, method 250 proceeds to the second stage 270 shown in FIG. 5 in which an optimized conveyor speed of screw conveyor 220 of centrifuge 200 is set. It may be understood that centrifuge 200 continues to be operated with bowl 202 operating at the optimized bowl speed during the execution of both second stage 270 and third stage 290. In other words, in at least this exemplary embodiment, the execution of the method steps of both second stage 270 and third stage 290 do not result in a change in a bowl speed of bowl 202, and instead, the bowl speed of bowl 202 remains fixed at the optimized bowl speed.

In this exemplary embodiment, second stage 270 of method 250 begins at method step 272 where the conveyor speed of conveyor 220 is increased from the initial conveyor speed by a predetermined conveyor speed increment. The conveyor speed increment may be the same magnitude as, or different from, the magnitude of the bowl speed increment. The conveyor speed increment may be predefined change in revolutions per minute (RPM) of the screw conveyor 220 about rotational axis 205. In order to maintain the bowl 202 at the optimized bowl speed as the conveyor speed of screw conveyor 220 is changed, the conveyor speed of screw conveyor 220 may be changed by changing (increasing or decreasing) a differential speed or RPM between the screw conveyor 220 and bowl 202. Controller 120 may execute method step 272 automatically using the conveyor VFD 126.

Method 250 proceeds from method step 272 to method step 274 which determines whether the density of the effluent drilling mud discharged by the centrifuge 200 has decreased in response to the increase in conveyor speed of the screw conveyor 220 executed at method step 272. Similar to method step 256 described above, method step 274 may be executed by controller 120 based on measurements provided by effluent density sensor 112. In response to a “YES” determination at method step 274, method 250 proceeds to method step 276 where the conveyor speed of screw conveyor 220 is increased by an additional conveyor speed increment. Method 250 proceeds to method step 278 where it is determined where, similar to method step 260 described above, it is determined whether a reactive torque applied to one or more components of the centrifuge and feed pump have reached or exceeded the torque limit in response to the increase in conveyor speed at method step 276.

Should a “YES” determination be made at method step 278, then method 250 proceeds to method step 280 where an optimized conveyor speed of the screw conveyor 220 is set which provides the minimum density in the effluent drilling mud which does not exceed the torque limit. The optimized conveyor speed comprises the conveyor speed an increment less than the conveyor speed which triggered the “YES” determination at method step 278. Actions may be performed (e.g., by controller 120) in addition to setting the optimized bowl speed in response to a “YES” determination at method step 278. For example, should one of the torque limits have been met, then a speed of the feed pump may be reduced in an attempt to reduce the reactive torque which has met the torque limit. Additionally, should one of the torque limits have been exceeded, then operation of the centrifuge may be shutdown.

In some embodiments, method 250 may not include method step 278. In other embodiments, method 250 may include an additional method step between method steps 272, 274 which is similar to method step 278. Should a “NO” determination be made at method step 278, then method 250 proceeds to method step 282 where it is determined whether the density of the effluent drilling mud discharged by the centrifuge 200 has decreased in response to the additional increase in conveyor speed of the screw conveyor 220 executed at method step 276.

If the determination at method step 282 is “YES,” then the method 250 returns to method step 276 as indicated by arrow 283 where the conveyor speed of screw conveyor 220 is increased by an additional increment. The conveyor speed of screw conveyor 220 may be increased iteratively until a until a “NO” determination is made at either method step 278 or method step 282. Following a “NO” determination at method step 282, method 250 proceeds to method step 280 where an optimized conveyor speed of screw conveyor 220 is set which provides the minimum density in the effluent drilling mud and which does not exceed the torque limit. This optimized conveyor speed comprises the conveyor speed following the final incremental increase in conveyor speed at method step 276 before the “NO” determination is made at method step 282.

Returning to method step 274, should a “NO” determination be made at step 274, method 250 proceeds from step 274 to method step 284 where the conveyor speed of screw conveyor 220 is decreased from the initial conveyor speed by the predetermined conveyor speed increment in a manner similar to the reduction in bowl speed executed at the method step 266 described above. Method 250 proceeds to method step 286 where it is determined whether the density of the effluent drilling mud discharged by the centrifuge 200 has decreased in response to the decrease in the conveyor speed executed at method step 284. If the determination at method step 268 is “YES,” then the method 250 returns to method step 284 as indicated by arrow 287 where the conveyor speed of screw conveyor 220 is decreased by an additional conveyor speed increment.

Once a “NO” determination at method step 286, method 250 proceeds to method step 280 where an optimized conveyor speed of screw conveyor 220 is set which provides the minimum density in the effluent drilling mud and which does not exceed the torque limit. This optimized conveyor speed comprises the conveyor speed following the final incremental decrease in conveyor speed at method step 284 before the “NO” determination is made at method step 286. In some embodiments, method 250 may include an additional method step between method steps 284, 286 similar to method step 278 in which it is determined whether a reactive torque applied to the centrifuge and feed pump has reached or exceeded the predetermined torque limit in response to the decrease in conveyor speed of the screw conveyor 220.

As described above, in this exemplary embodiment, second stage 270 sets an optimized conveyor speed of the screw conveyor 220 of centrifuge 200. The method steps described above of second stage 270 may be executed automatically without manual intervention by the controller 120 of centrifuge system 100. Following the setting of the optimized conveyor speed at method step 280, method 250 proceeds to the third stage 290 shown in FIG. 5 in which an optimized inlet flowrate of centrifuge 200 is set. It may be understood that centrifuge 200 continues to be operated with screw conveyor 220 operating at the optimized conveyor speed (and bowl 202 operating at the optimized bowl speed) during the execution of third stage 290.

In this exemplary embodiment, third stage 290 of method 250 begins at method step 292 where the inlet flowrate of centrifuge 200 is increased from the preset inlet flowrate by a predetermined inlet flowrate increment. The inlet flowrate increment may be predefined change in a rotational speed of an impeller of the feed pump in RPM. Alternatively, the inlet flowrate increment may be a predefined change in flowrate (e.g., in gallons per second (GPS)) of the inlet flow of drilling fluid entering centrifuge 200. Controller 120 may execute method step 292 automatically using the feed VFD 128.

Method 250 proceeds from method step 292 to method step 294 which determines whether the density of the effluent drilling mud discharged by the centrifuge 200 has decreased in response to the increase in inlet flowrate executed at method step 292. Method step 294 may be executed by controller 120 based on measurements provided by effluent density sensor 112. In response to a “YES” determination at method step 294, method 250 proceeds to method step 296 where the inlet flowrate of centrifuge 200 is increased by an additional inlet flowrate increment. Method 250 proceeds to method step 298 where it is determined where, similar to method step 260 described above, it is determined whether a reactive torque applied to one or more components of the centrifuge and feed pump have reached or exceeded the torque limit in response to the increase in inlet flowrate at method step 296.

Should a “YES” determination be made at method step 298, then method 250 proceeds to method step 300 where an optimized inlet flowrate is set which provides the minimum density in the effluent drilling mud which does not exceed the torque limit. The optimized inlet flowrate comprises the inlet flowrate an increment less than the inlet flowrate which triggered the “YES” determination at method step 298. Actions may be performed (e.g., by controller 120) in addition to setting the optimized bowl speed in response to a “YES” determination at method step 298. For example, should one of the torque limits have been met, then a speed of the feed pump may be reduced in an attempt to reduce the reactive torque which has met the torque limit. Additionally, should one of the torque limits have been exceeded, then operation of the centrifuge may be shutdown.

In some embodiments, method 250 may not include method step 298. In other embodiments, method 250 may include an additional method step between method steps 292, 294 which is similar to method step 298. Should a “NO” determination be made at method step 298, then method 250 proceeds to method step 302 where it is determined whether the density of the effluent drilling mud discharged by the centrifuge 200 has decreased in response to the additional increase in inlet flowrate produced by feed pump 114 executed at method step 296.

If the determination at method step 302 is “YES,” then the method 250 returns to method step 296 as indicated by arrow 303 where the inlet flowrate of centrifuge 200 is increased by an additional increment. The inlet flowrate of centrifuge 200 may be increased iteratively until a until a “NO” determination is made at either method step 298 or method step 302. Following a “NO” determination at method step 302, method 250 proceeds to method step 300 where an optimized inlet flowrate of centrifuge 200 is set which provides the minimum density in the effluent drilling mud and which does not exceed the torque limit. This optimized inlet flowrate comprises the inlet flowrate following the final incremental increase in inlet flowrate at method step 296 before the “NO” determination is made at method step 302.

Returning to method step 294, should a “NO” determination be made at step 294, method 250 proceeds from step 294 to method step 304 where the inlet flowrate of centrifuge 200 is decreased from the preset inlet flowrate by the predetermined inlet flowrate increment in a manner similar to the reduction in bowl speed executed at the method step 266 described above. Method 250 proceeds to method step 306 where it is determined whether the density of the effluent drilling mud discharged by the centrifuge 200 has decreased in response to the decrease in the inlet flowrate executed at method step 304. If the determination at method step 268 is “YES,” then the method 250 returns to method step 304 as indicated by arrow 307 where the inlet flowrate of centrifuge 200 is decreased by an additional inlet flowrate increment.

Once a “NO” determination at method step 306, method 250 proceeds to method step 300 where an optimized inlet flowrate of centrifuge 200 is set which provides the minimum density in the effluent drilling mud and which does not exceed the torque limit. This optimized inlet flowrate comprises the inlet flowrate following the final incremental decrease in inlet flowrate at method step 304 before the “NO” determination is made at method step 306. In some embodiments, method 250 may include an additional method step between method steps 304, 306 similar to method step 298 in which it is determined whether a reactive torque applied to the centrifuge and feed pump has reached or exceeded the predetermined torque limit in response to the decrease in inlet flowrate produced by feed pump 114.

As described above, in this exemplary embodiment, third stage 290 sets an optimized inlet flowrate of centrifuge 200. The method steps described above of third stage 290 may be executed automatically without manual intervention by the controller 120 of centrifuge system 100. In this exemplary embodiment, the completion of third stage 290 completes the optimization of centrifuge system 100 by controller 120. However, it may be understood that in other embodiments other components of centrifuge system 100 may be optimized by controller 120 to thereby optimize the operation of centrifuge system 100. In other embodiments, not all of the bowl speed, conveyor speed, and inlet flowrate may be optimized (e.g., only the bowl speed and conveyor speed may be optimized, etc.) as part of optimizing the centrifuge system 100. Additionally, in other embodiments, the ordering of the optimization of the different components of centrifuge system 100 may vary. As one example, in another embodiment, the inlet flowrate of centrifuge 200 may first be optimized, following the optimization of the conveyor speed and the bowl speed.

Method 250 may be executed multiple times by the controller 120. For example, controller 120 may execute method 250 each time the current mode of operation of centrifuge system 100 is changed. In another example, controller 120 may execute method 250 at fixed intervals of time, and/or in response to a command signal inputted to the controller 120 by an operator of centrifuge system 100.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A centrifuge system for separating solids from a fluid flow, the centrifuge system comprising:
an inlet fluid conduit configured to receive a flow of raw fluid;
an outlet fluid conduit configured to receive a flow of effluent fluid;
an effluent sensor located along the outlet fluid conduit and configured to determine a density of the effluent fluid received by the outlet fluid conduit;
a centrifuge comprising an inlet configured to receive the raw fluid from the inlet fluid conduit, an effluent outlet configured to discharge the effluent fluid received by the outlet fluid conduit, and a solids outlet configured to discharge solids separated from the raw fluid by the centrifuge;
a bowl rotatable about a rotational axis of the centrifuge, and a conveyor located within the bowl and configured to rotate about the rotational axis, and wherein the conveyor is configured to separate solids present in the raw fluid received by the inlet to thereby produce the effluent fluid discharged at the effluent outlet;
a feed pump in fluid communication with both the inlet fluid conduit and the inlet of the centrifuge, wherein the feed pump is configured to pump the raw fluid to the inlet of the centrifuge at a selected flowrate; and
a controller connected to the effluent sensor and the centrifuge, wherein the controller is configured to automatically adjust at least one of a speed of the feed pump, a rotational speed of the bowl of the centrifuge about the rotational axis, and a rotational speed of the conveyor of the centrifuge about the rotational axis in response to a change in the density of the effluent fluid as determined by the effluent sensor.

2. The centrifuge system of claim 1, further comprising:
a bowl drive connected to the bowl of the centrifuge and the controller and configured to control the rotational speed of the bowl;
a conveyor drive connected to the conveyor of the centrifuge and the controller and configured to control the rotational speed of the conveyor; and
a pump drive connected to the feed pump and the controller and configured to control the speed of the feed pump.

3. The centrifuge system of claim 2, wherein each of the bowl drive, the conveyor drive, and the pump drive comprises a variable frequency drive (VFD).

4. The centrifuge system of claim 1, wherein the controller comprises a memory device in which a preset rotational speed of the bowl, a preset rotational speed of the conveyor, and a preset initial speed of the feed pump are stored.

5. The centrifuge system of claim 4, wherein the controller is configured to automatically increase at least one of the speed of the feed pump from the preset initial speed of the feed pump by a predetermined feed pump speed increment, the rotational speed of the bowl from the preset rotational speed of the bowl by a predetermined bowl rotational speed increment, and the rotational speed of the conveyor from the preset rotational speed of the conveyor by a predetermined conveyor rotational speed increment.

6. The centrifuge system of claim 1, wherein the controller is configured to automatically decrease a speed of the feed pump in response to the controller determining that an alarm torque limit of the centrifuge has been met.

7. The centrifuge system of claim 6, wherein the alarm torque limit comprises at least one of a bowl alarm torque limit associated with the bowl of the centrifuge, a conveyor alarm torque limit associated with the conveyor of the centrifuge, and a feed pump alarm torque limit associated with the feed pump.

8. The centrifuge system of claim 1, wherein the controller is configured to automatically shut down operation of the centrifuge in response to the controller determining that an alarm torque limit of the centrifuge has been exceeded.

9. A method of operating a centrifuge system for separating solids from a fluid flow, the method comprising:
(a) pumping a flow of a raw fluid by a feed pump to an inlet of a centrifuge of the centrifuge system;
(b) operating the centrifuge to separate solids present in the raw fluid received by the inlet to thereby produce an effluent fluid from the raw fluid;
(c) discharging a flow of the effluent fluid from an effluent outlet of the centrifuge;
(d) discharging a flow of solids separated from the raw fluid from a solids outlet of the centrifuge;
(e) determining a density of the flow of the effluent fluid discharged from the centrifuge by an effluent sensor; and
(f) automatically adjusting by a controller of the centrifuge system at least one operational parameter of the centrifuge system in response to a change in the density of the effluent fluid as determined by the effluent sensor.

10. The method of claim 9, further comprising:
(g) operating a component of the centrifuge system associated with the at least one operational parameter at a preset initial value stored in a memory device of the controller; and
(h) automatically adjusting by the controller at least one operational parameter from the preset initial value by a predetermined increment.

11. The method of claim 10, wherein:
(g) comprises at least one of operating the feed pump at a preset initial pump speed, operating a bowl of the centrifuge at a preset initial bowl speed, and a conveyor of the centrifuge at a preset initial conveyor speed.

12. The method of claim 11, wherein:
(h) comprises automatically increasing by the controller at least one of a speed of the feed pump from the initial pump speed by a predetermined pump speed increment, a speed of the bowl of the centrifuge from the initial bowl speed by a predetermined bowl speed increment, and a speed of the conveyor of the centrifuge from the initial conveyor speed by a predetermined conveyor speed increment.

13. The method of claim 9, further comprising:
(g) automatically decreasing by the controller a speed of the feed pump in response to the controller determining that an alarm torque limit of the centrifuge has been met.

14. The method of claim 13, wherein the alarm torque limit comprises at least one of a bowl alarm torque limit associated with the bowl of the centrifuge, and a conveyor alarm torque limit associated with the conveyor of the centrifuge, and a feed pump alarm torque limit associated with the feed pump.

15. The method of claim 9, further comprising:
(g) automatically shutting down by the controller operation of the centrifuge in response to the controller determining that an alarm torque limit of the centrifuge has been exceeded.

16. A method of operating a centrifuge system for separating solids from a fluid flow, the method comprising:
(a) pumping a flow of a raw fluid by a feed pump to an inlet of a centrifuge of the centrifuge system;
(b) rotating both a bowl and a conveyor of the centrifuge about a rotational axis of the centrifuge system to separate solids present in the raw fluid received by the inlet to thereby produce an effluent fluid;
(c) discharging a flow of the effluent fluid from an effluent outlet of the centrifuge;
(d) discharging a flow of solids separated from the raw fluid from a solids outlet of the centrifuge;
(e) determining a density of the flow of the effluent fluid discharged from the centrifuge by an effluent sensor; and
(f) automatically adjusting by a controller of the centrifuge system at least one of a speed of the feed pump, a rotational speed of the bowl of the centrifuge about the rotational axis, and a rotational speed of the conveyor of the centrifuge about the rotational axis in response to a change in the density of the effluent fluid as determined by the effluent sensor.

17. The method of claim 16, further comprising:
(g) automatically operating by the controller at least one of the feed pump at a preset initial pump speed stored in a memory device of the controller, the bowl of the centrifuge at a preset initial bowl speed stored in a memory device of the controller, and the centrifuge at a preset initial centrifuge speed stored in a memory device of the controller;
wherein (f) comprises automatically increasing at least one of the speed of the feed pump from the initial pump speed, the rotational speed of the bowl of the centrifuge from the initial bowl speed, and the rotational speed of the conveyor of the centrifuge from an initial conveyor speed in response to a change in the density of the effluent fluid as determined by the effluent sensor.

18. The method of claim 16, further comprising:
(g) automatically decreasing by the controller the speed of the feed pump in response to the controller determining that an alarm torque limit of the centrifuge has been met.

19. The method of claim 18, wherein the alarm torque limit comprises at least one of a bowl alarm torque limit associated with the bowl of the centrifuge, and a conveyor alarm torque limit associated with the conveyor of the centrifuge, and a feed pump alarm torque limit associated with the feed pump.

20. The method of claim 16, further comprising:
(g) automatically shutting down by the controller operation of the centrifuge in response to the controller determining that an alarm torque limit of the centrifuge has been exceeded.
